(19) United States
(12) Patent Application Publication
(10) Pub. No.: US 2026/0012339 A1
(43) Pub. Date: Jan. 8, 2026

(54) Collapse-Based Cryptographic Decryption Using Total Wave Modified Schrödinger Equation (TWMSE)

(71) Applicant: LARRY LIM KHENG CHEONG, SINGAPORE (SG)

(72) Inventor: LARRY LIM KHENG CHEONG, SINGAPORE (SG)

(21) Appl. No.: 19/328,113

(22) Filed: Sep. 13, 2025

Related U.S. Application Data
(63) Continuation of application No. 19/172,805, filed on Apr. 8, 2025.

(51) Int. Cl. H04L 9/08

(52) U.S. Cl. CPC H04L 9/088; H04L 9/0852

(57) ABSTRACT

A system and method for cryptographic decryption using deterministic collapse resonance based on the Total Wave Modified Schrödinger Equation (TWMSE). An encrypted problem state is encoded as a system wavefunction, while candidate solutions are represented as observer wavefunctions. A collapse field with tunable parameters ensures destructive interference cancels incorrect candidates and constructive resonance deterministically selects the correct solution. Unlike brute-force search or probabilistic quantum measurement, the method achieves decryption in a single engineered collapse. Hardware embodiments include optical photonic systems, neuromorphic processors, and resonant field architectures. Applications extend to RSA, Diffie-Hellman, elliptic curve cryptography, lattice-based post-quantum protocols, blockchain, and secure messaging frameworks. Proof-of-concept demonstrations on small instances, including factorization of $N=15$, illustrate feasibility at toy scale. Scaling to larger cryptosystems is envisioned through adaptive parameter control, resonance calibration, and experimental implementation.

### FIELD OF THE INVENTION

The invention relates to cryptography and computational methods, specifically to systems and apparatus for decryption of encrypted data using deterministic collapse resonance derived from the Total Wave Modified Schrödinger Equation.

### BACKGROUND OF THE INVENTION

Current cryptographic security relies on computational hardness of problems such as prime factorization, discrete logarithms, elliptic curves, and lattice-based constructs. Classical computers scale exponentially with problem size, and even quantum computers require probabilistic measurement, limiting practical impact. There exists a need for a deterministic computational framework capable of directly collapsing onto correct cryptographic solutions without reliance on brute force or probability.

### SUMMARY OF THE INVENTION

The invention provides a collapse-based decryption system in which:
A ciphertext is represented as a system wavefunction.
Candidate keys are represented as observer wavefunctions.
A collapse field, governed by tunable parameters, is constructed such that only the correct solution resonates constructively with the system state.
Collapse deterministically selects the correct key, which is then output and verified.

The invention bypasses brute-force scaling, offering deterministic decryption potentially applicable to all major cryptographic primitives, including post-quantum protocols.

### DETAILED DESCRIPTION

### Collapse Function

$$C ( r , t ) = \sum \_j [ γ\_j {\vert Ψ\_j \vert}^{2} - δ\_j Re ( Ψ\_j ) ] Ψ\_p$$

Y_p: system wavefunction (encrypted state).
Y j: observer wavefunctions (candidate keys).
Y_j, 8_j: tunable collapse parameters.
C(r,t): collapse field producing deterministic resonance.

### Process Flow

1. Encode ciphertext into system wavefunction.
2. Encode candidate keys as observer wavefunctions.
3. Construct collapse field with tunable parameters.
4. Induce deterministic collapse resonance.
5. Output collapsed state as correct cryptographic key.
6. Verify solution by direct substitution.

### Hardware Embodiments

Optical Photonic Systems: interference of phase-modulated light fields.
Neuromorphic Processors: spiking attractor dynamics simulating collapse.
Resonant/Gravitational Fields: standing-wave resonances tuned to solution states.

### Applications

RSA factorization and Diffie-Hellman discrete logs.
Elliptic curve cryptography.
Post-quantum lattice protocols (Kyber, LWE).
Blockchain and secure messaging (e.g., PQXDH).
General mathematical problem solving via deterministic collapse computing.

### Additional Considerations and Counterpoints

It is recognized that certain aspects of the present invention may invite critique or require further development. In particular, questions may arise regarding (i) the encoding of cryptographic problems into system wavefunctions, (ii) the calibration of collapse parameters, and (iii) the scalability of collapse fields to large key spaces. The following considerations are provided to demonstrate that the invention is both conceived and enabled, even if full empirical proof is deferred to future work.

### Encoding of Problem States

The invention contemplates encoding cryptographic problems into wavefunctions in a manner analogous to embeddings used in quantum annealing and Ising-model formulations. The ciphertext or cryptographic instance is not solved in advance, but instead mapped into an interference landscape where valid solutions correspond to stable resonances. Efficient encoding methods are expected to be system-specific and may be optimized experimentally.

### Calibration of Collapse Parameters

The collapse parameters γ_j, δ_j are not arbitrary; they represent tunable boundary conditions within the collapse function. Calibration may be achieved by adaptive control methods, feedback loops, or automated machine-learning optimization. Importantly, calibration does not require brute-force search across all candidate solutions, but instead relies on adjusting field dynamics to suppress unstable resonances while amplifying the correct solution.

### Scalability and Proof-of-Concept

While large-scale cryptographic instances (e.g., RSA-2048) present engineering challenges, the invention is enabled by proof-of-concept demonstrations on smaller instances. For example, an RSA modulus $N=15$ can be encoded as a system wavefunction, with candidate factors represented as observer wavefunctions. Application of the collapse function shows that resonance occurs only for the true factors (3 and 5). This toy example illustrates the principle of deterministic collapse, and provides a foundation for scaling studies.

By addressing these counterpoints explicitly, the present specification demonstrates possession of the invention and provides sufficient detail for one skilled in the art to attempt construction and validation. The invention should therefore be regarded as enabled under 35 U.S.C. § 112, notwithstanding that full-scale experimental prototypes remain to be implemented.

1. A system for cryptographic decryption, comprising:
a module configured to encode an encrypted problem state as a system wavefunction Ψ_p;
a plurality of observer wavefunctions Ψ_j representing candidate solution states;
a collapse field computation unit configured to apply a collapse function of the form:
$$C ( r , t ) = \sum \_j [ γ\_j {\vert Ψ\_j \vert}^{2} - δ\_j Re ( Ψ\_j ) ] Ψ\_p$$
wherein deterministic collapse resonance selects a correct solution state.

2. A method for cryptographic decryption, comprising:
encoding a ciphertext into a system wavefunction;
encoding candidate keys as observer wavefunctions;
constructing a collapse field with tunable parameters;
inducing deterministic collapse resonance between the system wavefunction and the correct observer wavefunction;
outputting the correct cryptographic key as the collapsed state.

3. A collapse-based computational apparatus, comprising:
a wavefunction encoding module for mapping computational states to interference patterns;
a collapse orchestration module for tuning collapse parameters γj, δj
a collapse readout module configured to extract the resonant solution, wherein the apparatus performs decryption, factorization, or discrete logarithm resolution without probabilistic search.

4. The system of claim 1, wherein the physical substrate is an optical photonic system encoding wavefunctions as interference phase patterns.

5. The system of claim 1, wherein the physical substrate is a neuromorphic processor simulating collapse resonance via spiking attractor dynamics.

6. The system of claim 1, wherein the physical substrate is a resonant field architecture configured to implement collapse thresholds through standing wave modes.

7. The method of claim 2, wherein collapse parameters γj, δj are tuned to suppress non-solution states through destructive interference.

8. The method of claim 2, wherein collapse deterministically yields the decryption key without probabilistic measurement.

9. The apparatus of claim 3, wherein the collapse orchestration module dynamically adjusts parameters to maintain resonance stability.

10. The system of claim 1, wherein multiple collapse fields operate in parallel to resolve independent cryptographic instances simultaneously.

11. The system of claim 1, wherein the collapse function is implemented as an analog physical model.

12. The system of claim 1, wherein the collapse function is implemented as a digital simulation of wave interference approximating physical collapse.

13. The method of claim 2, further comprising validating the collapsed solution through substitution into the cryptographic problem.

14. The apparatus of claim 3, further comprising an error correction module to eliminate spurious outcomes caused by noise.

15. The system of claim 1, wherein the collapse field is applied to decrypt blockchain protocols including Ethereum and Bitcoin.

16. The system of claim 1, wherein the collapse field is applied to lattice-based post-quantum cryptographic schemes, including Learning With Errors (LWE) and Kyber key encapsulation mechanisms.

17. The system of claim 1, wherein collapse resonance is applied to hybrid secure messaging protocols, including Post-Quantum Extended Diffie-Hellman (PQXDH).

18. The system of claim 1, wherein collapse fields are deployed in a distributed or cloud-based architecture, enabling remote or parallelized cryptographic decryption.

19. The method of claim 2, wherein collapse resonance is configured to simultaneously satisfy multiple cryptographic hardness assumptions, including RSA factorization combined with lattice constraints.

20. The apparatus of claim 3, wherein the system is applied to financial consensus mechanisms, including blockchain validation, smart contract execution, and distributed ledger integrity verification.
